(19) United States
(12) Patent Application Publication
(10) Pub. No.: US 2007/0118867 A1
(43) Pub. Date: May 24, 2007

(54) Digital television signal, digital television receiver, and method of processing digital television signal

(76) Inventors: Jin Pil Kim, Seoul (KR); Kyung Mee Lee, Seoul (KR)

Correspondence Address: MCKENNA LONG & ALDRIDGE LLP;Song K. Jung, 1900 K Street, N.W., Washington, DC, 20006, US

(21) Appl. No.: 11/360,607

(22) Filed: Feb. 24, 2006

(30) Foreign Application Priority Data
Nov. 21, 2005 (KR) 10-2005-0111502

(51) Int. Cl. H04N 7/173; G06F 3/00; G06F 13/00; H04N 7/16; H04N 5/445

(52) U.S. Cl. 725/100; 725/131; 725/139; 725/39

(57) ABSTRACT

A digital television (DTV) signal for use in a digital television (DTV) receiver includes an extended text table (ETT) for data services. The ETT includes a header and a message body. The header includes a table identification (ID) extension field which serves to establish uniqueness of the ETT, and the message body includes an extended text message (ETM). The table ID extension field includes a data identification of a data event associated with the ETT. The data identification specifies a unique identification number of the data event, and the ETM provides detailed descriptions of the data event. A section-filtering unit included in the DTV receiver can detect one or more pertinent ETTs in an efficient manner by section-filtering a plurality of ETTs using their PIDs and table ID extension fields.

This application also claims the benefit of Korean Patent Application No. 10-2005-0111502, filed on Nov. 21, 2005, which is hereby incorporated by reference.

### BACKGROUND OF THE INVENTION

1. Field of the Invention

The present invention relates to a digital broadcast, and more particularly, to a digital television signal and a method and apparatus of processing a digital television signal.

2. Discussion of the Related Art

Generally, digital broadcast services include an audio/video broadcast service and a data broadcast service. To provide theses services, there exists a protocol for transferring data tables included within packets transferred by a multiplexed transport stream.

Also, a program and system information protocol (hereinafter, PSIP) is a protocol for channel tuning and broadcast schedule transmission in ATSC (advanced television systems committee) as the digital broadcasting standard in terrestrial and cable digital broadcasting environments. In addition, the PSIP is a standard protocol for a transfer of tables included within packets transferred by a multiplexed transport stream.

The PSIP defines many PSIP tables for the various purpose, and each PSIP table includes one or more sections which are similar to those of the program and system information (PSI) tables defined by MPEG (moving picture experts group). Each section included in a PSIP table includes a header containing basic information of the section and a body containing the actual data constituting the section. A broadcast receiver uses the basic information included in headers of various sections received from a broadcast transmitter in order to select (or detect) one or more pertinent sections, and this is often referred to as section-filtering. An example of the basic information is a table identifier which identifies a PSIP table.

However, a certain group of PSIP tables (e.g., a group of event information tables or extended text tables) have a common table identification. Therefore, the digital television (DTV) receiver is not able to distinguish them simply by section-filtering. In this case, the DTV receiver must parse bodies of the PSIP sections in order to detect a pertinent section, and this greatly increases the signal processing time and decreases the system's overall efficiency.

### SUMMARY OF THE INVENTION

Accordingly, the present invention is directed to a digital television (DTV) signal in a DTV receiver, apparatus for receiving the same and method thereof that substantially obviate one or more problems due to limitations and disadvantages of the related art.

An object of the present invention is to provide a DTV signal in a DTV receiver.

Another object of the present invention is to provide an apparatus for receiving the DTV signal and method thereof.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a digital television (DTV) signal for use in a DTV receiver includes an extended text table (ETT) for data services. The ETT for data services includes a header and a message body. The header includes a table identification (ID) extension field which serves to establish uniqueness of the ETT, and the message body includes an extended text message (ETM). The table ID extension field includes a data identification of a data event associated with the ETT. The data identification specifies a unique identification number of the data event, and the ETM provides detailed descriptions of the data event.

Optionally, the digital television (DTV) signal may further include an event ETT which is for audio/video services. The event ETT also includes a header and a message body. The header includes a table ID extension field which serves to establish uniqueness of the ETT for audio/video services, and the message body includes an ETM. The table ID extension field includes an event identification of an audio/video event associated with the event ETT. The event identification specifies a unique identification number of the audio/video event, and the ETM provides detailed description of the audio/video event.

In addition, the digital television (DTV) signal may further include a channel ETT, which includes a header and a message body. The header includes a table ID extension field which serves to establish uniqueness of the channel ETT, and the message body includes an ETM. The table ID extension field includes a source identification of a virtual channel associated with the channel ETT. The ETM provides detailed descriptions of the virtual channel, and the source identification specifies a programming source of the virtual channel.

In another aspect of the present invention, a DTV receiver includes a tuner, a demodulator, and a section-filtering unit (e.g., a demultiplexer). The tuner is tuned to receive a DTV signal, and the demodulator demodulates the DTV signal. The demodulated signal includes a plurality of ETTs.

Each ETT includes a header containing a table ID extension field which serves to establish uniqueness of each TT, and a message body containing an ETM. The section-filtering unit detects at least one pertinent ETT for data services by section-filtering the plurality of ETTs based on two conditions. One condition is such that the pertinent ETT has a common PID value, and the other condition is such that a table ID extension field included in the pertinent ETT includes specific or non-duplicative data identification. The data identification specifies a unique identification number of a data event associated with the pertinent ETT.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1A illustrates an EPG display according to one embodiment of an audio/video broadcast service of the present invention;

FIG. 1B illustrates an EPG display according to one embodiment of a data broadcast service of the present invention;

FIG. 2 is a diagram of a general syntax of a PSIP table associated with the present invention;

FIG. 3 is an exemplary diagram of a bit stream syntax of channel ETT according to the present invention;

FIG. 4 is an exemplary diagram of a bit stream syntax of event ETT according to the present invention;

FIG. 5 is an exemplary diagram of a bit stream syntax of data event ETT according to the present invention;

FIG. 6A is a block diagram of a digital television receiver to receive channel ETT and event ETT according to the present invention;

FIG. 6B is a block diagram of a digital television receiver to receive data event ETT according to the present invention;

FIG. 7 illustrates a structure of a database associated with the present invention;

FIG. 8 is a flowchart illustrating a method for detecting a non-duplicative channel ETT section according to the present invention;

FIG. 9 is a flowchart illustrating a method for detecting a specific channel ETT section according to the present invention;

FIG. 10 is a flowchart illustrating a method for detecting a non-duplicative event ETT section according to the present invention;

FIG. 11 is a flowchart illustrating a method for detecting a specific event ETT section according to the present invention;

FIG. 12 is a flowchart illustrating a method for detecting a non-duplicative data event ETT section according to the present invention; and

FIG. 13 is a flowchart illustrating a method for detecting a specific data event ETT section according to the present invention;

### DETAILED DESCRIPTION OF THE INVENTION

Reference will now be made in detail to a digital television (DTV) signal including tables, apparatus for receiving the same and method thereof according to the preferred embodiments of the present invention, examples of which are illustrated in the accompanying drawings. In the present invention, there are an audio/video broadcast service and a data broadcast service in digital broadcast services. Wherever possible, the same reference numbers will be used throughout the drawings to refer to the same or like parts.

First of all, terminologies used in the description of the present invention are defined as considering functions in the present invention, which are variable according to usual practice or intentions of those who skilled in the art. Hence, their definitions shall be given based on the overall contents of the present invention.

### FIRST EMBODIMENT

In providing a digital broadcast service, both transmitting and receiving sides follows a protocol, which is a compromise for transmitting and receiving methods in transmitting/receiving the service. Hence, a transmitter transmits tables for an audio/video broadcast service, an EPG (electronic program guide) service and a data broadcast service and a receiver then receives the transmitted tables.

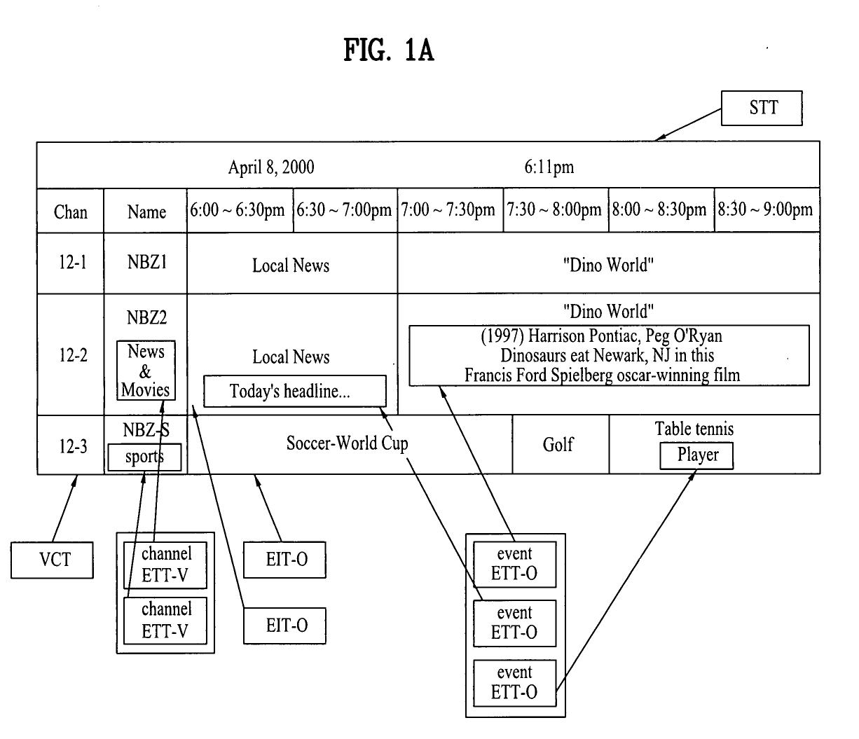

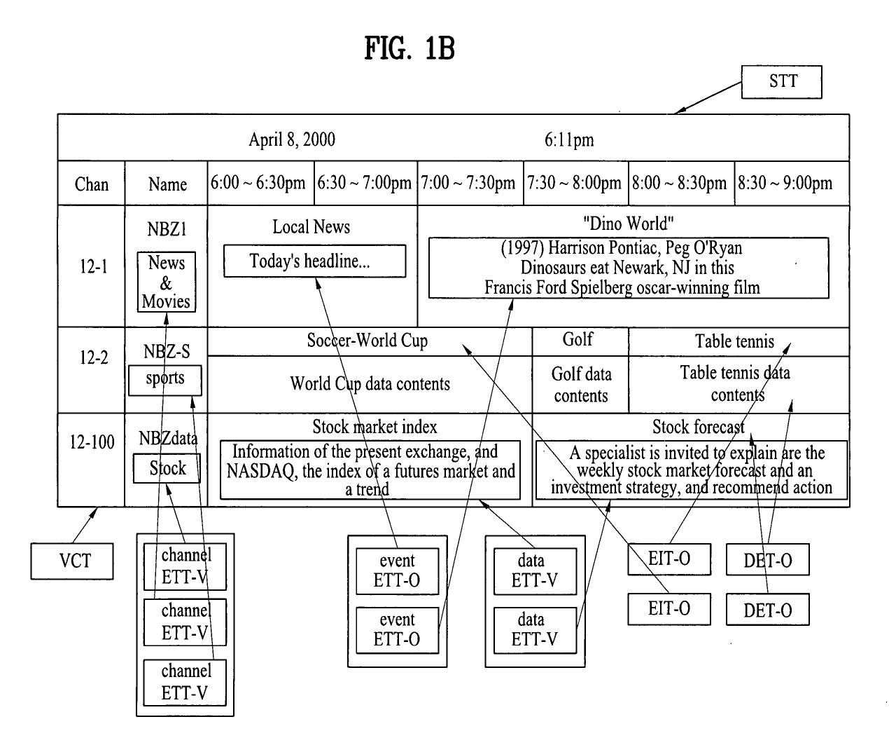

The present invention intends to deal with an extended text table (ETT) among the tables included in a broadcast signal. Preferentially, correlations of tables defined in the protocol with functions in the exemplary EPG screen shown in FIG. 1A and FIG. 1B are explained prior to describing the ETT as follows. FIG. 1A illustrates an EPG display according to one embodiment of an audio/video broadcast service of the present invention and FIG. 1B illustrates an EPG display according to one embodiment of a data broadcast service of the present invention.

First of all, FIG. 1A shows an EPG including a VCT (virtual channel table) having no data broadcasting, a channel ETT, an EIT and an event ETT. Referring to FIG. 1A, information about a current date and time at a most upper end on an EPG screen is delivered via STT (system time table) and exemplarily shows “Apr. 8, 2000 6:11 p.m.”.

A most left side “Chan” part in FIG. 1A displays channel numbers 12-1, 12-2 and 12-3 of virtual channels delivered from VCT. In this case, each of the virtual channels has source identification having a unique value. A name part follows each of the channels. The name part means a channel short name included in each of the virtual channels and exemplarily shows NBZ1, NBZ2 or NBZ-S. Each of the virtual channels can send a channel information message having a more extended meaning, which is forwarded via channel ETT-V for each of the virtual channels connected to the source identification obtained from the VCT. Although the channel 12-1 is represented as the name “NBZ1”, channel ETT connected to the source identification of the channel does not exist.

A channel ETT called “News & Movies” exists in the channel 12-2 and a channel ETT called “sports” exists in the channel 12-3. In this case, instances of the two channel ETTs has the same PID (packet identification) and is represented as ETT-V. And, each instance of the channel ETTs has the same table type, version number, table identification and the like. In the channel 12-1, an event having a title of “Local News” at 6:00˜7:00 pm and an event having a title of “Dino World” at 7:00˜9:00 pm exist as broadcast programs. This information is delivered via EIT-0 table having the same value of source identification of a virtual channel 12-1.

In the channel 12-2, an event having a title of “Local News” at 6:00˜7:00 pm and an event having a title of “Dino World” at 7:00˜9:00 pm exist as broadcast programs. This information is delivered via EIT-0 table having the same value of source identification of a virtual channel 12-2. In this case, it is exemplarily shown that each of the events in the channel 12-2 includes a broadcast content message having a more extended content. This is forwarded via event ETT. In the former event, event ETT for the event named “Today's headline . . . ” exists. In the latter event, event ETT named “(1997) Harrison Pontiac, Peg O'Ryan Dinosaurs eat Newark, N.J. in the Francis Ford Spielberg oscar-winning film” exists.

In the channel 12-3, an event having a title of “Soccer-World Cup” at 6:00˜7:30 pm, an event having a title of “Golf” at 7:30˜8:00 pm, and an event (EIT-0) having a title of “Table Tennis” at 8:00˜9:00 pm exist as broadcast programs. These events are delivered via EIT-0 table having the same value of source identification of a virtual channel 12-3. In this case, it is shown that an event ETT (event ETT-v) to forward a broadcast content message having an extended content named “Player” exists in the event having the title named “Table Tennis”.

Hence, in FIG. 1A, there exist three event ETTs to forward the broadcast content messages having the extended contents for several events. Each of the event ETTs has the same values of PID, version number, table identification and table type.

FIG. 1B shows an EPG including information about a data event for data broadcast, which is different from that of FIG. 1A. Channels acquired from a VCT are constructed with a virtual channel 12-1 for audio/video broadcast not including data broadcast, a virtual channel 12-2 for audio/video broadcast including data broadcast information, and a data broadcast dedicated virtual channel 12-100 for data broadcast without audio/video broadcast contents. Namely, the virtual channel 12-1 is equivalent to the aforesaid channel 12-2 in FIG. 1A. And, the virtual channel 12-2 is equivalent to the channel 12-3 in FIG. 1A.

Yet, since the virtual channel contains data information for data broadcast, a data event table (DET) is delivered to transfer a title, broadcast schedule and the like of each data event for the data broadcast information. For instance, an event having a title of “Soccer-World Cup” is broadcast 6:00˜7:30 pm over the virtual channel 12-2. According to the schedule, a data event having a name of “World Cup Data contents” is transferred via DET-0. Hence, as can be seen by the EPG diagram shown in FIG. 1B, a viewer can enjoy data broadcast contents associated with World Cup over the virtual channel 12-2 while watching audio/video of World Cup Soccer during 6:00˜7:30 pm.

As can be seen by the EPG diagram shown in FIG. 1B, a program of a data broadcast service of a data event having a title of “Golf data contents” is broadcast 7:30˜8:00 p.m. over the virtual channel 12-2 together with an audio/video broadcast service of an event having a title of “Golf”. Subsequently, an event having a title of “Table tennis” is broadcast 8:00˜9:00 pm as well as a data broadcast service of a data event having a title of “Table tennis data contents”. In this case, each event information of soccer, golf and table tennis in the virtual channel 12-2 is delivered via EIT-0, and each data event information is delivered via DET-0.

The virtual channel 12-100 indicates a data broadcast dedicated service channel not including audio/video service and is delivered via VCT together with the virtual channels 12-1 and 12-2. And, the virtual channel 12-100 has a unique source identification value different form that of other virtual channels and has a channel name called “NBZdata” as a channel short name. Moreover, the virtual channel 12-100 transmits a channel ETT linkable to the channel 12-100 by source identification to transmit text message data named “stock” as a channel description message having a more extended meaning. In the data broadcast dedicated service virtual channel 12-100, as shown in FIG. 1B, event information indicating a broadcast program schedule for the audio/video service is not shown. Namely, it means that the EIT-0 needs not to be sent.

On the other hand, a data event having a title of “Stock market index” is transmitted 6:00˜7:30 pm and a data event having a title of “Stock forecast” is broadcast 7:30˜9:00 pm, for example. For the former data event, a data event ETT containing an extended text message named “Information over the present exchange, NASDAQ (National Association of Securities Dealers Automated Quotations), the index of a futures market and a trend” is transmitted. For the latter data event, a data event ETT containing an extended text message named “A specialist is invited to explain are the weekly stock market forecast and an investment strategy and recommend action” is transmitted. Hence, a DTV receiver is enabled to service data event and its detailed information for a data broadcast service via the EPG function.

In case of the mixed channel 12-2, DET is transmitted together to give the data event information about each event in the channel 12-3 of FIG. 1A. For instance, World Cup data contents DET is transmitted together for the “Soccer-World Cup” event, golf data contents DET is transmitted together for the “Golf” event, and table tennis data contents DET is transmitted together for the “Table tennis” event. Hence, if there is a viewer's request, the data broadcast service is provided together with the audio/video broadcast service.

In case of the data broadcast dedicated channel 12-100, a channel ETT named “Stock” is transmitted by source identification connecting VCT and channel ETT together. The data event named “Stock market index” is transmitted 6:00˜7:30 pm, and the data event named “Stock forecast” is transmitted 7:30˜9:00 pm.

For the former data event, a data event ETT named “Information over the present exchange, and NASDAQ, the index of a future market and a trend” is transmitted. For the latter data event, a data event ETT named “A specialist is invited to explain are the Weekly stock market forecast and an investment strategy, and recommend action” is transmitted. Thus, a data broadcast service is carried out.

The tables associated with the present invention are explained as follows. First of all, there are a VCT having information about virtual channel viewed by a viewer, an EIT and DET enabling an EPG service, an ETT for the EIT and DET and the like. In this case, the ETT associated with a data broadcast service is called a data event ETT and an ETT about the audio/video service is used.

The EIT and DET are preferentially explained and the ETT for each of the services proposed by the present invention will be explained later.

The EIT is associated with an audio/video broadcast service and contains information (titles, start times, etc) for events on defined virtual channels. The event is, in most cases, a typical TV program. Up to 128 EITs may be transmitted and each of them is referred to as EIT-k, with k =0, 1, . . . , 127. And, each EIT is represented as information about at least on event.

And, the DET is associated with a data broadcast service and plays a role similar to that of the EIT. In particular, the DET contains a schedule of data events having the similar concept of the event in the audio/video service and information associated with each of the data events. In this case, the DET includes information (titles, start times, etc.) for a data service of the defined virtual channel of 3-hour unit. The DET is to provide data information for a prescribed time unit and is represented as DET-k. In this case, the k is 0˜127. And, each DET-k has a multiple instance. The DET will define a data service usable on a special virtual channel by data identification during 3-hour time unit. Each data event within the DET has data identification of a unique value. The DET-0 will list all available data events for a current 3-hour unit, and the DET-1 will list all available data events for a next 3-hour unit. Such a method is applied to all the other DET-k.

The ETT for each of the services is explained as follows. As the ETT, there are an event ETT recording detailed information of each event for an audio/video broadcast service, a channel ETT recording detailed information for each virtual channel for an audio/video broadcast and Data broadcast service, and a data event ETT recording detailed information about each data event for a data broadcast service. In this case, the ETT contains extended text message (ETM) streams, which are optional and are used to provide detailed descriptions of the virtual channels (channel ETM) and events (event ETM). An ETM is a multiple string data structure, and thus, it may represent a description in several different languages.

First of all, the event ETT for the audio/video broadcast service is explained as follows. The event ETT is mapped to each EIT. In particular, information for events belonging to EIT-0 to EIT-127 is recorded at ETT-0 to ETT-127, respectively. In this case, information about at least one or more events included in each EIT can be represented as one section. Each of the events has unique event identification. And, each of the events is identified by the corresponding event identification. And, ETM location indicates a presence or non-presence of an extended text message (ETM) for each of the events and a location of each of the events.

Secondly, the data event ETT for the data broadcast service is explained as follows. The data event ETT is mapped to each DET. In particular, information for data events belonging to DET-0 is recorded at data event ETT-0, information for data events belonging to DET-1 is recorded at data event ETT-1, and information for data events belonging to DET-127 is recorded at data event ETT-127. In this case, information about at least one or more data events included in each DET can be represented as one section. ‘data_id’ exists in each of the data events to identify the corresponding data event. And, ETM location indicates where the data event ETT recording detailed information of each of the data events exists.

Finally, the channel ETT, which is common to the two services, is used in case that channel information having a more extended meaning is required for n-virtual channels included in one physical channel. In this case, each of the n-virtual channels defined in the VCT uses source identification in identifying each channel source. In particular, if there are n-virtual channels in one physical channel, each of the virtual channels has source identification. In this case, the source identification should have a unique value. And, ETM location defined in VCT decides whether a channel ETT exists in each of the virtual channels. The ETM location indicates a presence or non-presence of an extended text message (ETM) in each of the virtual channels and a location of each of the virtual channels, which is equivalent to that of the event ETT or the data event ETT.

Each of the ETTs can be constructed with at least one or more sections and includes ETM identification identifying the corresponding ETT and an extended text message (ETM) about the corresponding ETT.

The ETM identification indicates event identification of a corresponding event in case that the ETT is the event ETT. And, the ETM identification indicates source identification of a corresponding virtual channel in case that the ETT is the channel ETT. In this case, the ETM identification is linked to event ETM identification of a corresponding event in case of the event ETT section, to data ETM identification of a corresponding data event in case of the data event ETT section, and to channel ETM identification of a corresponding virtual channel in case of the channel ETT section. Moreover, in each ETM identification, the event ETM identification includes source identification and event identification, the data ETM identification includes source identification and data identification, and the channel ETM identification includes source identification.

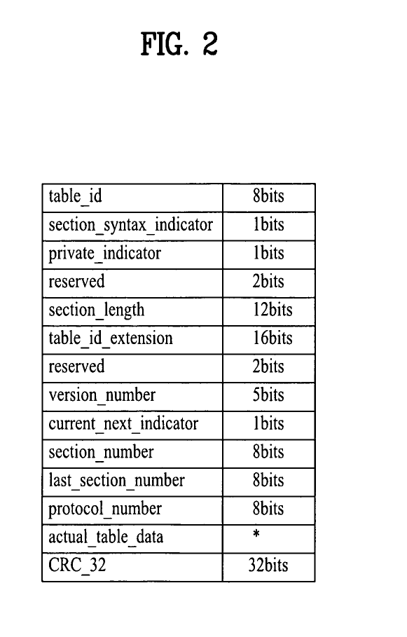

Besides, the DTV receiver performs a section-filtering on each of the received ETT sections. A structure of the section is preferentially explained prior to the section-filtering. FIG. 2 is a diagram of a general syntax of a PSIP table associated with the present invention. In this case, the section is constructed by combining data structures. Each of the sections starts from table identification field and ends to CRC-32 field.

A table section of the syntax shown in FIG. 2 is divided into a header having a mutually common form, a message body recording actual data according to a purpose of the table section, and a trailer for an error check and correction of the table section. The header starts from table identification field to protocol version field. The message body starts from ETM identification field to extended text message field. And, the trailer is CRC 32 field. Besides, the respective fields will be explained in detail later.

As mentioned in the foregoing description, the DTV receiver performs the section-filtering on each of the ETT sections. In the present invention, the section-filtering, which was already received and is duplicative with another, is discarded and then a non-duplicative section is received only or a specific section is received only. In particular, the present invention intends to carry out the section-filtering in a manner of filtering a header of the received section only.

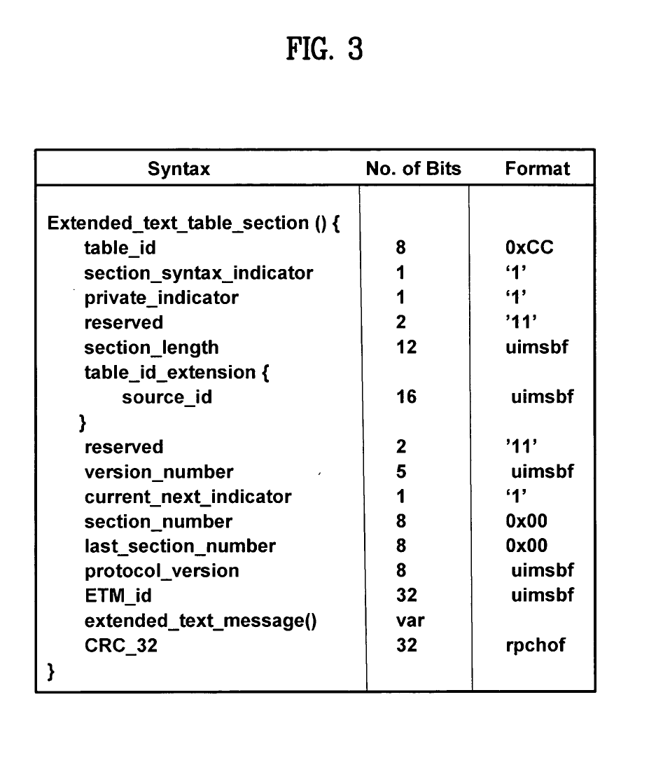

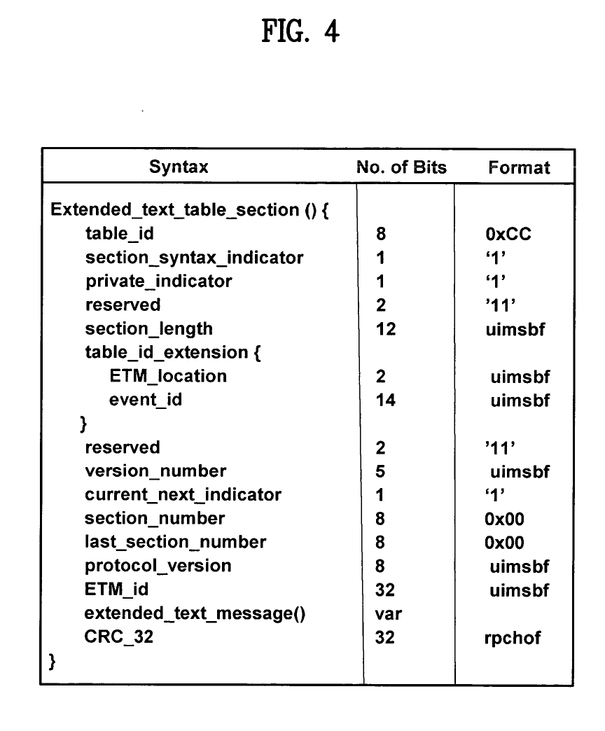

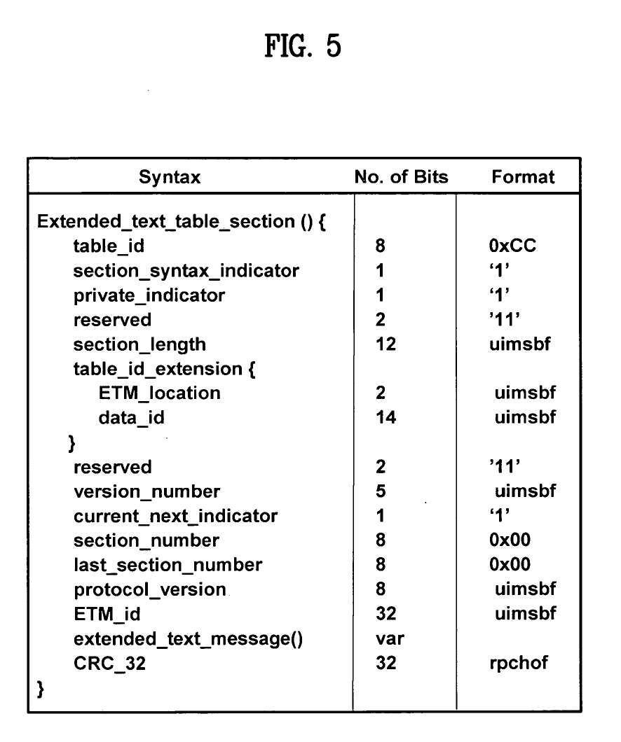

A syntax configured to enable section-filtering carried out on the header only according to the present invention is explained as follows. FIG. 3 is an exemplary diagram of a bit stream syntax of channel ETT according to the present invention, FIG. 4 is an exemplary diagram of a bit stream syntax of event ETT according to the present invention, and FIG. 5 is an exemplary diagram of a bit stream syntax of data event ETT according to the present invention. In particular, FIG. 3 is common to audio/video service and data service, FIG. 4 is associated with an audio/video service, and FIG. 5 is associated with a data service.

In the present invention, a header is filtered only and the section-filtering is carried out using ETT table identification (ID) extension field among fields constructing the header of the table section. Fields constructing the syntaxes shown in FIGS. 2 to 5 are explained as follows. For simple and clear explanation, English expression of the syntax is used as it is but is marked by double quotation marks.

First of all, each field constructing a header of the syntax is explained as follows. A “table_id” identifies the section as belongs to an ETT and is an 8-bit field. In this case, table identification of an ETT section of the audio/video or data service is ‘0xCC’. A “section_syntax_indicator” is set to ‘1’ and is a 1-bit field. It denotes that the section follows the generic section syntax beyond the section length field.

A “private_indicator” is set to ‘1’ and is a 1-bit field. A “section_length” field is to specify the number of remaining bytes in the section immediately following the section length field up to the end of the section. The value of the section length field shall be no larger than 4,093.

A “ETT_table_id_extension” is a field associated with the present invention, which will be explained later. A “version_number” is a 5-bit field. For the channel ETT, the field indicates the version number of the channel ETT. The version number shall be incremented by 1 modulo 32 when any ETM in the channel ETT changes. For event ETT, the field indicates the version number of event ETT-i, where i, as in the EIT case, is the index of time span. The version number shall be incremented by 1 modulo 32 when any ETM in the event ETT-j when j is not equal to i. The value of this field shall be identical to that of the corresponding entry in the MGT. And, five bits are allocated for DET. The version number will be incremented if a prescribed field within the DET is varied. A value of the field will indicate a value according to version number of DET-k within MGT.

A “current_next_indicator” is a 1-bit field and is always set to ‘1’ for the ETT sections. The ETT sent is always currently applicable. A “section_number” is an 8-bit field and the value of the field shall always be ‘0x000’. A “last_section_number” is an 8-bit field and the value of the field shall always be ‘0x000’. A “protocol_version” is an 8-bit unsigned integer field whose function is to allow, in the future, this table type to carry parameters that may be structured differently than those defined in the current protocol. At present, the only valid value for protocol version is zero. Non-zero values of protocol version may be used by a future version of this standard to indicate structurally different tables.

Secondly, fields of the message part are explained as follows. A “ETM_id” field is a unique 32-bit identifier of this extended text message (ETM). The identifier follows a regular rule. By the rule, in case of channel ETM identification, source identification is written in a most significant bit (MSB) b31 and two least significant bits (LSB) b1 and b0 are written as ‘00’. By the rule, in case of event ETM identification, source identification is written in a most significant bit (MSB) b31, event identification is written in a bit b15, and ‘10’ is written in least significant bits (LSB) b1 and b0. Moreover, in case of data ETM identification, source identification is written in a most significant bit (MSB) b31, data identification is written in a bit b15, and ‘10’ is written in least significant bits (LSB) b1 and b0.

An “extended_text_message( )” field indicates the extended text message (ETM) in the format of a multiple string structure.

Finally, a field of the trailer is explained as follows. A “CRC_32” field is a 32-bit field that contains the CRC value that ensures a zero output from the registers in the decoder after processing the entire Transport Stream ETT section.

As mentioned in the foregoing description, the present invention performs a section-filtering on the received ETT section by filtering the header of the ETT section having the detailed information about the virtual channel, event and data event. Hence, by the present invention, a non-duplicative or specific section among the received ETT sections can be selectively received per channel, event or data event without being duplicative with another.

For this, in the present invention, ETT table ID extension field constructing the header of the ETT is used. Namely, in case that the received ETT section is event ETT, event identification and ETM location are defined in the field to be used for the section-filtering. In case that the received ETT section is data event ETT, data identification and ETM location are defined in the filed to be used for the section-filtering. In case of channel ETT, source identification is defined in the field to be used for the section-filtering.

An “ETT_table_id_extension” field has a 16-bit field unsigned integer value that serves to establish the uniqueness of each ETT instance when the tables appear in transport stream packets with common PID values. The ETT table ID extension field shall be set to a value such that separate ETT instances appearing in transport stream packets with common PID values have a unique ETT table ID extension field value. A table type of the ETT can be previously known from MGT (master guide table) before the ETT is received. In particular, the table type of the ETT is ‘0x0004’ in case of channel ETT, ‘0x0200˜0x027F’ in case of event ETT, or ‘0x1100˜0x117F’ in case of data event ETT.

FIG. 3 shows a channel ETT having an ETT table type of ‘0x0004’. In this case, 16-bit source identification connecting the VCT to channel ETT is written in the ETT table id extension”. And, the source identification should have the same value of source identification written in VCT and ETM identification.

FIG. 4 shows an event ETT having an ETT table type of ‘0x0200˜0x027F’. In this case, the ETT table ID extension field is a 16-bit field. ETM location field is written in two bits of the sixteen bits and unique event identification connecting the VCT to event ETT is written in fourteen bits. In this case, the event identification should have the same value of an event identification value of the corresponding event of EIT-k and an event identification value in the ETM identification should have the same value as well.

FIG. 5 shows a data event ETT having an ETT table type of ‘0x1100˜0x117F’. In this case, the ETT table ID extension field is a 16-bit field. The ETM location field is written in two bits of the sixteen bits and unique event identification connecting the VCT to data event ETT is written in fourteen bits. In this case, the data identification should have the same value of a data identification value of the corresponding data event of DET-k and a data identification value in the ETM identification should have the same value as well.

In the present invention, as mentioned in the forgoing description, event identification, data event identification and source identification are written in ETT table ID extension field constructing a header of each received ETT (event, data event, and channel) section. By means of the field, the section-filtering is enabled with the header only without parsing a message body of each of the received ETT sections. Namely, in the present invention, the event identification, data event identification and source identification are written in the ETT table ID extension field and the header including the ETT table ID extension field of each of the received ETT sections is filtered. In doing so, by filtering the header including the ETT table ID extension field, the section-filtering can be performed in a manner that a non-duplicative section is received only by discarding an ETT section duplicative with a previously-received section or in a manner that a specific section is received only.

Hence, in performing the section-filtering on each of the received ETT sections, the message body of each of the ETT sections needs not to be parsed. As mentioned in the foregoing description, by receiving a non-duplicative ETT section or a specific ETT section, a process time can be reduced to raise system efficiency. The more the ETT sections exist, the more efficient the system gets.

### SECOND EMBODIMENT

A digital television (DTV) receiver receiving a DTV signal including an ETT according to a second embodiment of the present invention is explained as follows.

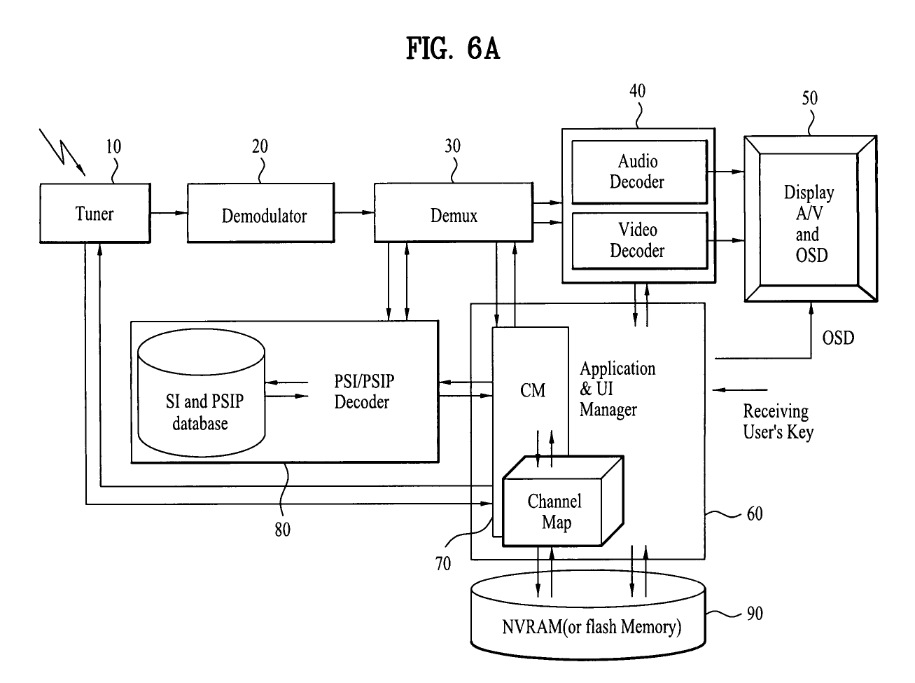

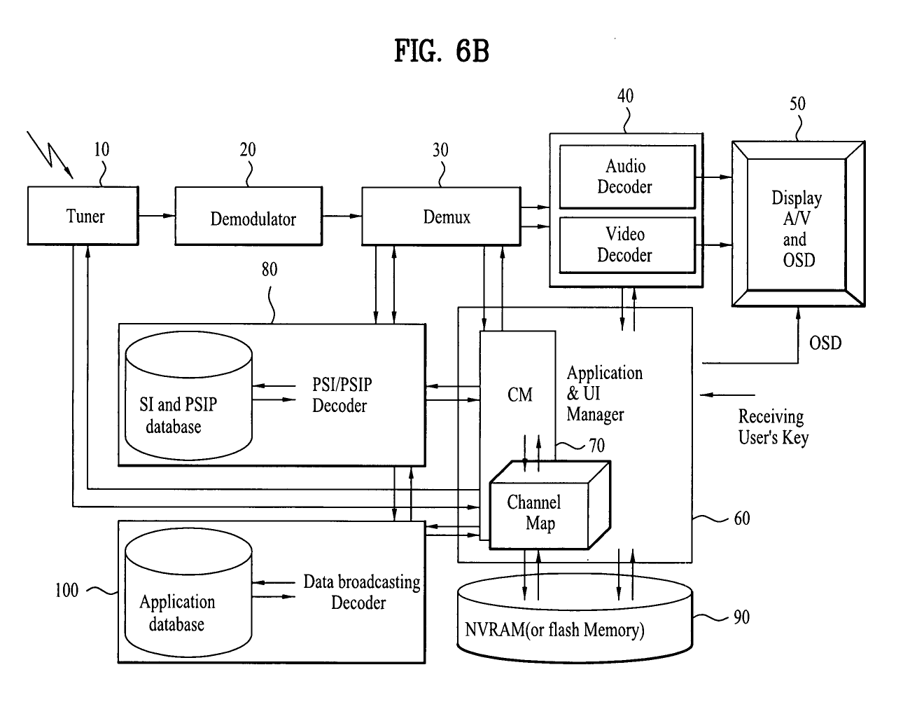

FIG. 6A is a block diagram of a digital television receiver to receive channel ETT and event ETT according to the present invention. And, FIG. 6B is a block diagram of a digital television receiver to receive data event ETT according to the present invention. In this case, a DTV receiver in FIG. 6A or FIG. 6B receives and processes tables and audio/video transport streams according to the present invention.

A tuner 10 receives a terrestrial or cable DTV signal via an antenna. In this case, a reception process of the tuner 10 is controlled by a channel manager 70. In particular, the tuner 10 reports a result and strength of the DTV signal received by the DTV receiver and transfer the DTV signal received by the DTV receiver to a demodulator 20.

In case that a terrestrial broadcast is received, the demodulator 20 performs 64-VSB (vestigial sideband) or 256-VSB demodulation. In case that a cable broadcast is received, the demodulator 20 performs 64-QAM (quadrature amplitude modulation) or 256-QAM demodulation. And, the demodulator 20 transfers a demodulated signal to a demultiplexer 30.

The DTV receiver shown in FIG. 6A or FIG. 6B is provided for an audio/video broadcast service or a data broadcast service and is divided into one part performing a section-filtering on an ETT section by a header and the other part parsing the received ETT section. In this case, the section-filtering part is conducted by the demultiplexer (DEMUX) 30 and the parsing part is conducted by a PSI/PSIP decoder 80.

First of all, the section-filtering part is explained as follows. The demultiplexer 30 performs demultiplexing to filter off audio, video and PSI/PSIP tables from transport packets transferred from the demodulator 20. Demultiplexing of the PSI/PSIP tables is carried out under the control of the PSI/PSIP decoder 80 and a data broadcast decoder 100. In particular, the demultiplexer 30 checks a header common to the PSI/PSIP table to perform the section-filtering on the received PSI/PSIP table under the control of the PSI/PSIP decoder 80 and the data broadcast decoder 100.

And, the demultiplexer 30 generates a section of the PSI/PSIP table for the audio/video broadcast service and then transfers it to the PSI/PSIP decoder 80. Moreover, the demultiplexer 30 generates a section of data broadcast data for the data broadcast service and then transfers it to the PSI/PSIP decoder 80. Demultiplexing of the audio/video transport packets is carried out under the control of the channel manager 70. In particular, if an audio/video PID of a corresponding virtual channel is set, the demultiplexer 30 demultiplexes an elementary stream of the audio/video to transfer to an audio/video decoder 40. Hence, the demultiplexer 30 performs the section-filtering on the audio/video data, PSI/PSIP table and the like in a manner of filtering the header only. And, data for each section generated from the section-filtering is transferred to the corresponding decoder.

The corresponding decoder is explained as follows. The audio/video decoder 40 decodes elementary stream packets of audio/video transferred from the demultiplexer 30 by MPEG2, AC3 or the like. The audio/video decoder 40 synchronizes the decoded audio/video data by a VDP (video player processor) and then transfers it to an output unit, i.e., an audio/video & OSD (on screen display) displayer 50.

The audio/video & OSD displayer 50 receives the decoded audio/video data transferred from the audio/video decoder 40 and then displays the received audio/video data via screen/speaker. In this case, the audio/video & OSD displayer 50 is under the control of OSD graphic data in case of displaying the data via the screen.

In case that there is a key input of a viewer watching the DTV, an application & UI (user interface) manager 60 responds to a viewer's request by displaying it on the screen via a graphic user interface. The application & UI manager 60 receives a decoded state of the audio/video signal from the audio/video decoder 40 and then controls the displayer 50 via the OSD according to the received audio/video state. And, the application & UI manager 60 controls the channel manager 70 to perform channel associated management, i.e., channel map management and to manage the PSI/PSIP decoder 80.

Moreover, the application & UI manager 60 stores/restores GUI control of the entire digital television receiver, user's request and a state of the DTV receiver in/from a NVRAM (or flash memory) 90. Furthermore, the application & UI manager 60 includes the channel manager 70. The channel manager 70 manages the channel map by controlling the tuner 10 and the PSI/PSIP decoder 80 to meet a channel request made by a viewer.

The channel manager 70 requests the PSI/PSIP decoder 80 to parse a table associated with a channel to be tuned and receives a report of parsing the table from the PSI/PSIP decoder 80. The channel manager 70 updates the channel map according to the reported parsing result and makes a decoding request by setting the audio/video PID in the demultiplexer 30.

Meanwhile, the PSI/PSIP decoder 80 corresponding to the table parsing part is explained as follows. The PSI/PSIP decoder 80, which is a PSI and PSIP control module, performs a slave operation under the control of the channel manager 70. Namely, the PSI/PSIP decoder 80 sets PIDs of the PSI/PSIP tables in the demultiplexer 30. The PSI/PSIP decoder 80 receives and parses the PSI section for an MPEG2 system and generates a PSI database. And, the PSI/PSIP decoder 80 receives and parses the PSIP section for ATSC and generates a SI/PSIP database.

In performing a parsing, the PSI/PSIP decoder 80 reads a rest actual section data portion, on which the section-filtering is not performed or cannot be performed, and then records it in the SI/PSIP database. Moreover, the PSI/PSIP decoder 80 processes DET for the data broadcast to transfer data broadcast associated tables, which are transmitted from the demultiplexer 30, to the data broadcast decoder 100.

And, the data broadcast decoder 100 stores files, which are generated from analyzing and assembling data broadcast data forwarded from the demultiplexer 30 to be transferred via the PSI/PSIP decoder 80, in an application database, monitors whether the data broadcast data is updated, and plays a role in keeping latest information stored in the application database through reanalysis of a corresponding part in case of occurrence of an update situation.

### THIRD EMBODIMENT

A method of performing a section-filtering by filtering a header of a received ETT (Extended Text Table) section only according to another embodiment of the present invention is explained as follows. Specifically, in performing the section-filtering, a method of checking and handling ETT table identification (ID) extension field included in a header of a received ETT section is explained as follows.

As can be seen in FIG. 1A or FIG. 1B, if the number of the virtual channels is raised, the number of the instances of the duplicative channel, event and data event ETTs will be increased as well.

As mentioned in the above description of the EPG, the present invention intends to perform a section-filtering on the numerous duplicative channel ETTs, event ETTs and data event ETTs to receive a non-duplicative ETT section not duplicative with a previously received one or a specific section only.

In case that a content of the channel ETT is changed (e.g., the version number is changed), one channel ETT that is changed in the above manner can be quickly received.

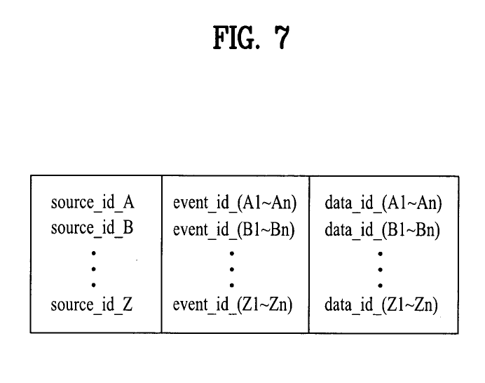

FIG. 7 illustrates a structure of a database (DB) associated with the present invention. Referring to FIG. 7, source identification, event identification and data identification required for audio/video and data services are stored in a DB. The DB shown in FIG. 7 includes a part storing the source identification linking VCT (Virtual Channel Table) and the channel ETT together for the audio/video services and data services, a part storing the event identification linking EIT and the event ETT together for the audio/video service, and a part storing the data identification linking DET (Data Event Table) and the data event ETT together for the data service.

The source identification, as shown in FIG. 7, is represented as “source_id_(A˜Z)”. In this case, the A˜Z corresponds to a virtual channel to represent the source identification existing in each of the channels A to Z.

In FIG. 7, the event identification is represented as “event_id_(A1˜An) to (Z1˜Zn)”. In this case, the ‘A˜Z’ corresponds to a virtual channel and the ‘1˜n’ indicates an event existing in each of the virtual channels. Namely, it means that an event corresponding to A1˜An exists in the virtual channel A.

In FIG. 7, the data identification is represented as “data_id_(A1˜An) to (Z1˜Zn)”. In this case, the A˜Z corresponds to a virtual channel and the ‘1˜n’ indicates an event existing in each of the virtual channels. Namely, it means that an event corresponding to A1˜An exists in the virtual channel A.

A process for performing a section-filtering in a manner of filtering a header of an ETT section received for the corresponding audio/video or data service by a DTV (digital television) receiver according to the present invention is explained as follows. As mentioned in the foregoing description, there exist an event ETT for an audio/video service, a data event ETT for a data service, and a channel ETT common to both of the services, which will be individually explained in the following description.

First of all, in performing the section-filtering, a DTV is turned on. A specific channel is previously selected in the DTV. A DTV receiver receives channel information via VCT, PAT (program association table) or PMT (program map table) . And, the DTV receiver sets an audio/video PID of a specific virtual channel determined by a viewer to the demultiplexer 30. Hence, the viewer watches the specific virtual channel. In the present invention, it is assumed that the viewer requests ETT information of the currently watched specific virtual channel. If a request for the ETT information is made, a section-filtering is initiated by filtering a header only.

As mentioned in the foregoing description, the section-filtering includes one case of receiving a non-duplicative ETT section only by discarding an ETT section duplicative with a previously received one and the other case of receiving a specific ETT section only. Moreover, a concept of the section-filtering may include a case of combining the former two cases together.

In the following description of the present invention, theses three cases will be taken as examples. First of all, the case of receiving a non-duplicative ETT section only by discarding an ETT section duplicative with a previously received one is explained as follows. And, ETTs for the respective services are individually explained.

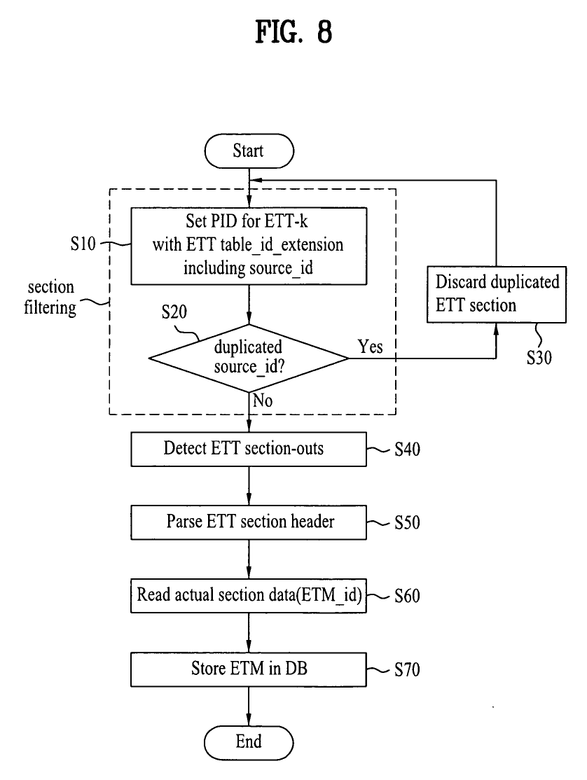

First of all, a channel ETT common to the services is explained as follows. FIG. 8 is a flowchart illustrating a method for detecting a non-duplicative channel ETT section according to the present invention. Referring to FIG. 8, if a user requests information of ETT, the PSI/PSIP decoder 80 controls the demultiplexer 30 to perform a section-filtering by a header. Namely, the PSI/PSIP decoder 80 sets a condition for the section-filtering in the demultiplexer 30. The demultiplexer 30 then filters the header according to the set condition.

In particular, a corresponding PID is set to the audio/video or data service using a table type acquired from the MGT (master guide table) and an ETT section having the set PID is received only. In doing so, a condition for receiving a section including ETT table ID extension field having source identification recorded therein only is applied to the received ETT section having met the former condition.

Thus, the DTV receiver performs the section-filtering through the two conditions. Hence, the DTV receiver receives the channel ETT section that meets the two conditions only (S1O).

The source identification recorded in ETT table ID extension field of the channel ETT section, which has met the conditions and is received by the receiver, is read out. It is then decided whether the read-out source identification is equal to source identification stored in a DB. In particular, it is decided whether the source identification recorded in the ETT table ID extension field of the received channel ETT section is equal to, i.e., duplicative with the source identification, which was generated from decoding VCT, stored in the DB (S20).

As a result of the decision (S20), if the two source identification's are equal to each other, it is decided that the received channel ETT section is duplicative with a previously received section. Hence, the duplicative channel ETT section is discarded. And, it goes back to the first step to receive a non-duplicative channel ETT section (S30).

As a result of the decision (S20), if the two source identification's are not equal to each other, it is decided that the received channel ETT section is a non-duplicative channel ETT section instead of being duplicative with a previously received section. And, it goes to a next step. So, the section-filtering process by the header in the demultiplexer 30 is completed. Hence, the above-explained steps S10 to S30 correspond to the explanation of the section-filtering by filtering the header in the demultiplexer 30 controlled by the PSI/PSIP decoder 80.

A process for parsing and processing the channel ETT section received through the section-filtering is explained as follows. In this case, the parsing is performed by the PSI/PSIP decoder 80. First of all, as a result of the decision (S20), if the two source identification's are not equal to each other, it is decided that the received channel ETT section is not an duplicative channel ETT section but a non-duplicative channel ETT section.

The PSI/PSIP decoder 80 then detects a channel ETT section-out received via the demultiplexer 30 (S40). The PSI/PSIP decoder 80 parses a header of the detected channel ETT section again (S50). And, the PSI/PSIP decoder 80 reads out ETM identification, which is actual section data, by parsing a message body of the channel ETT section (S60). An ETM (extended text message) is then stored in the DB (S70). Through the above-explained processes, one channel ETT section is processed or handled. If there exists another channel ETT section that is not received yet, the above-explained processes are repeated.

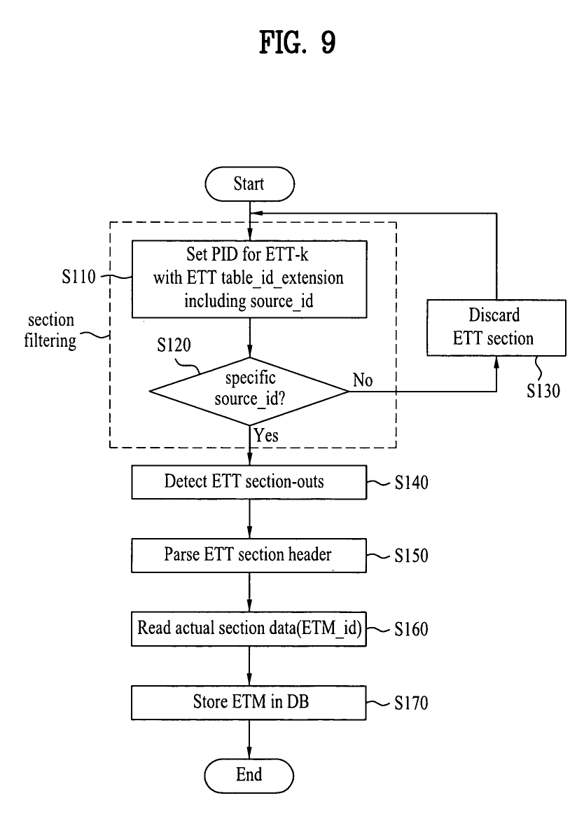

FIG. 9 is a flowchart illustrating a method for detecting a specific channel ETT section according to the present invention. A process for receiving a specific channel ETT section is basically identical to the process explained in FIG. 8. For convenience of explanation, a section-filtering part different from that of the process of FIG. 8 is explained only and the rest part will refer to the process of FIG. 8.

First of all, a corresponding PID is set to the audio/video or data service using a table type acquired from the MGT and an ETT section having the set PID is received only. In doing so, a condition for receiving a section including ETT table ID extension field having source identification recorded therein only is applied to the received ETT section having met the former condition. Thus, the DTV receiver performs the section-filtering through the two conditions. Hence, the DTV receiver receives the channel ETT section that meets the two conditions only (S110).

The source identification recorded in ETT table ID extension field of the channel ETT section, which has met the conditions and is received by the DTV receiver, is read out. It is then decided whether the read-out source identification is equal to source identification stored in a DB. In particular, it is decided whether the source identification recorded in the ETT table ID extension field of the received channel ETT section is equal to the source identification, which was generated from decoding VCT, stored in the DB (S120).

As a result of the decision (S120), if the two source identification's are not equal to each other, it is decided that the received channel ETT section is not a specific channel ETT section. Hence, the received channel ETT section is discarded (S130).

As a result of the decision (S120), if the two source identification's are equal to each other, it is decided that the received channel ETT section is the specific channel ETT section. And, it goes to a next step. So, the section-filtering process in the demultiplexer 30 is completed.

A parsing and handling process in the PSI/PSIP decoder 80 is equal to the process explained in FIG. 8, which is invoked in this description. Namely, steps S140 to S170 in FIG. 9 exactly correspond to the steps S40 to S70 in FIG. 8.

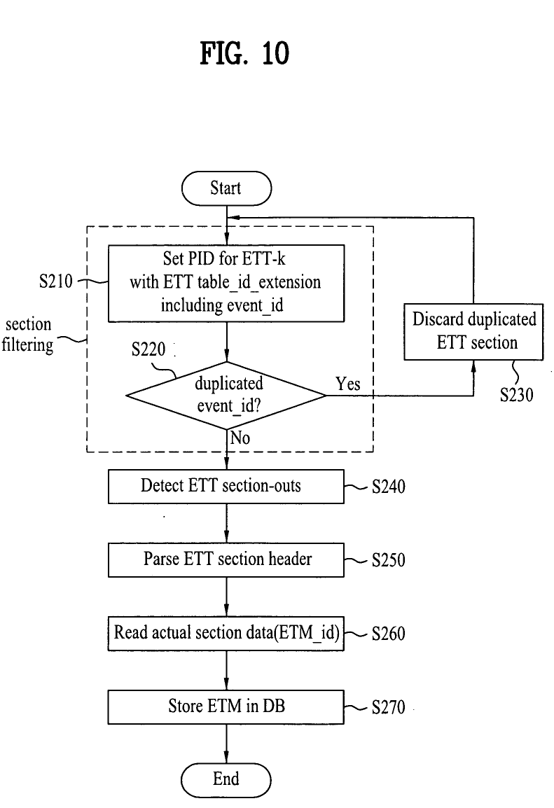

The event ETT for the audio/video broadcast service is explained in the following description. In explaining a received event ETT section according to the present invention, a process in FIG. 10 is similar to that of FIG. 8 or FIG. 9. Hence, a difference is intensively explained in the following description.

FIG. 10 is a flowchart illustrating a method for detecting a non-duplicative event ETT section according to the present invention. Referring to FIG. 10, a corresponding PID is set using a table type acquired from the MGT and an event ETT section having the set PID is received only. In doing so, a condition for receiving a section including ETT table ID extension field having event identification recorded therein only is applied to the received event ETT section having met the former condition.

Thus, the DTV receiver performs the section-filtering through the two conditions. Hence, the DTV receiver receives the event ETT section that meets the two conditions only (S210).

The event identification recorded in ETT table ID extension field of the event ETT section, which has met the conditions and is received by the DTV receiver, is read out. It is then decided whether the read-out event identification is equal to event identification stored in a DB. In particular, it is decided whether the event identification recorded in the ETT table ID extension field of the received event ETT section is equal to, i.e., duplicative with the event identification, which was generated from decoding VCT, stored in the DB (S220).

As a result of the decision (S220), if the two event identification's are equal to each other, it is decided that the received event ETT section is duplicative with a previously received section. (S230).

As a result of the decision (S220), if the two event identification's are not equal to each other, it is decided that the received event ETT section is a non-duplicative event ETT section instead of being duplicative with a previously received section. And, it goes to a next step. So, the section-filtering process in the demultiplexer 30 controlled by the PSI/PSIP decoder 80 is completed.

A process for parsing and processing the event ETT section received through the section-filtering is explained as follows. In this case, the parsing is performed by the PSI/PSIP decoder 80. First of all, as a result of the decision (S220), if the two event identification's are not equal to each other, it is decided that the received event ETT section is not an duplicative event ETT section but a non-duplicative event ETT section.

The PSI/PSIP decoder 80 then detects an event ETT section-out received via the demultiplexer 30 (S240). The PSI/PSIP decoder 80 parses a header of the detected event ETT section again (S250). And, the PSI/PSIP decoder 80 reads out ETM identification, which is actual section data, by parsing a message body of the parsed event ETT section (S260). An ETM (extended text message) is then stored in the database (DB) (S270). Through the above-explained processes, one event ETT section is processed or handled. If there exists another event ETT section that is not received yet, the above-explained processes are repeated.

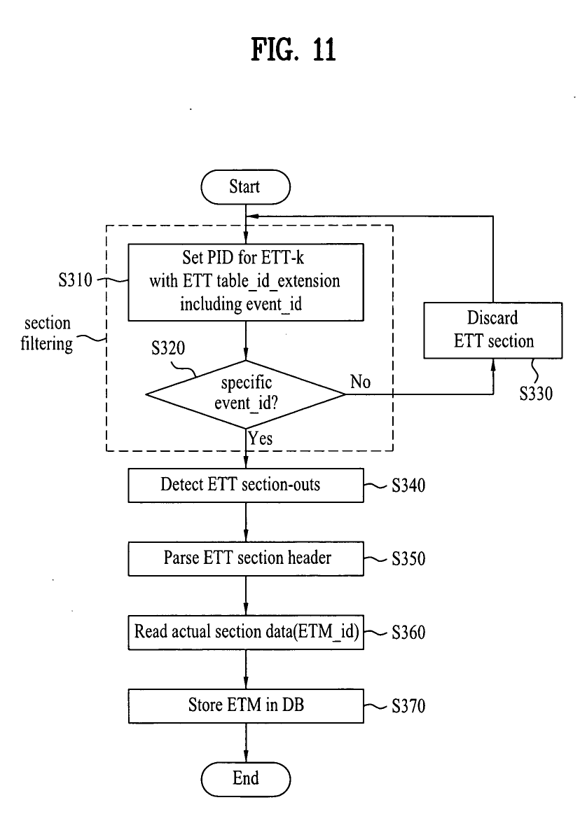

A process for receiving a specific event ETT section is explained as follows. FIG. 11 is a flowchart illustrating a method for detecting a specific event ETT section according to the present invention. A process for receiving a specific event ETT section is basically identical to the process explained in FIG. 10. For convenience of explanation, a section-filtering part different from that of the process of FIG. 10 is explained only and the rest part will refer to the process of FIG. 10.

First of all, a corresponding PID is set using a table type acquired from the MGT and an event ETT section having the set PID is received only. In doing so, a condition for receiving a section including ETT table ID extension field having event identification recorded therein only is applied to the received event ETT section having met the former condition. Thus, the DTV receiver performs the section-filtering through the two conditions. Hence, the DTV receiver receives the event ETT section that meets the two conditions only (S310).

The event identification recorded in ETT table ID extension field of the event ETT section, which has met the conditions and is received by the DTV receiver, is read out. It is then decided whether the read-out event identification is equal to event identification stored in a DB. In particular, it is decided whether the event identification recorded in the ETT table ID extension field of the received event ETT section is equal to the event identification, which was generated from decoding VCT, stored in the database (DB) (S320).

As a result of the decision (S320), if the two event identification's are not equal to each other, it is decided that the received event ETT section is not a specific event ETT section. Hence, the received event ETT section is discarded (S330).

As a result of the decision (S320), if the two source identification's are equal to each other, it is decided that the received event ETT section is the specific event ETT section. And, it goes to a next step. So, the process for performing the section-filtering in a manner of filtering the header in the demultiplexer 30 controlled by the PSI/PSIP decoder 80 is completed.

A process for parsing and handling the event ETT section received through the section-filtering is equal to the process explained in FIG. 10. Namely, steps S340 to S370 in FIG. 10 exactly correspond to the steps S240 to S270 in FIG. 10. So far, the above-explained descriptions of FIGS. 8 to 11 are dedicated to the ETT sections for the audio/video service.

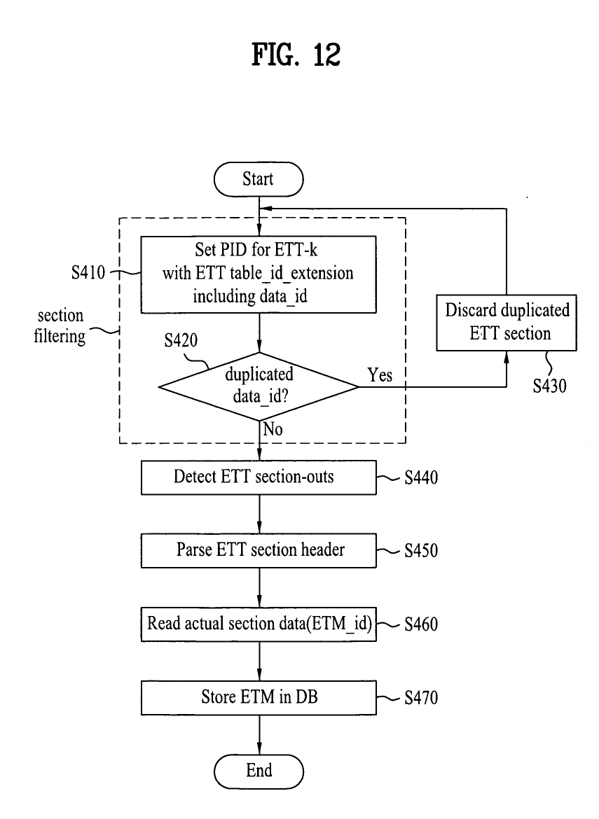

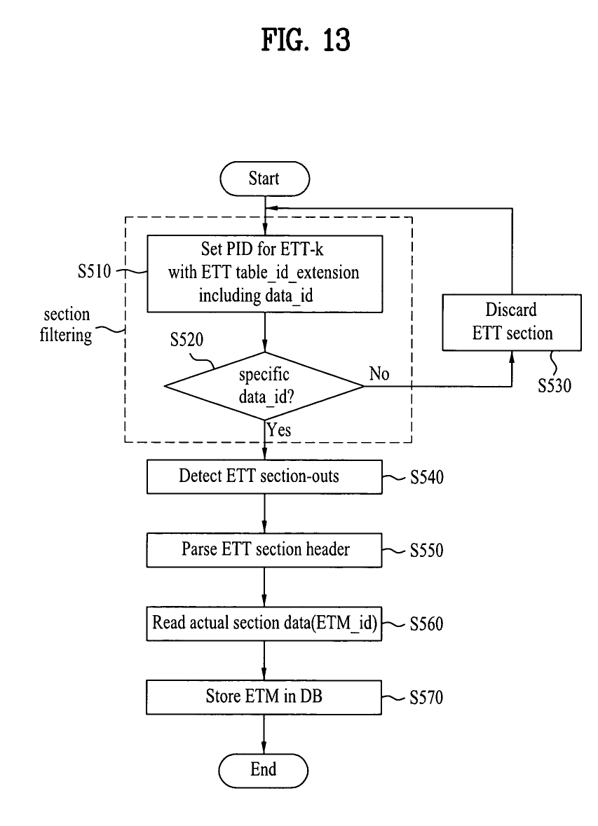

Hereinafter, ETT sections for the data broadcast service are explained in the following description. In doing so, as mentioned in the foregoing description, the explanation for a channel ETT for the audio/video and data services is identical, which refers to that of FIG. 8 or FIG. 9. Hence, a data event ETT in a data service, which corresponds to the event ETT in the audio/video broadcast service, is explained as follows. As a process for receiving each ETT section in a flowchart of FIG. 12 or FIG. 13 for the data event ETT is basically identical to that of FIGS. 8 to 11, differences will be intensively explained.

FIG. 12 is a flowchart illustrating a method for detecting a non-duplicative data event ETT section according to the present invention. Referring to FIG. 12, a corresponding PID is set using a table type acquired from the MGT and a data event ETT section having the set PID is received only. In doing so, a condition for receiving a section including ETT table ID extension field having data identification recorded therein only is applied to the received data event ETT section having met the former condition. Thus, the DTV receiver performs the section-filtering through the two conditions. Hence, the DTV receiver receives the data event ETT section that meets the two conditions only (S410).

The data identification recorded in ETT table ID extension field of the data event ETT section, which has met the conditions and is received by the receiver, is read out. It is then decided whether the read-out data identification is equal to data identification stored in a DB. In particular, it is decided whether the data identification recorded in the ETT table ID extension field of the received data event ETT section is equal to, i.e., duplicative with the data identification, which was generated from decoding VCT, stored in the database (DB) (S420).

As a result of the decision (S420), if the two data identification's are equal to each other, it is decided that the received data event ETT section is duplicative with a previously received section. So, the received ETT section is discarded and it goes back to the first step (S430).

As a result of the decision (S420), if the two data identification's are not equal to each other, it is decided that the received data event ETT section is a non-duplicative data event ETT section that is not duplicative with a previously received section. And, it goes to a next step. So, the section-filtering process in the demultiplexer 30 controlled by the PSI/PSIP decoder 80 is completed. And, a process for parsing and processing the data event ETT section received through the section-filtering is identical to that of FIGS. 8 to 11, of which explanation is skipped.

A flow for receiving a specific data event ETT section is explained as follows.

FIG. 13 is a flowchart illustrating a method for detecting a specific data event ETT section according to the present invention. As a process for receiving a specific data event ETT section is basically identical to that of FIG. 12, differences will be intensively explained. Referring to FIG. 13, a corresponding PID is set using a table type acquired from the MGT and a data event ETT section having the set PID is received only. In doing so, a condition for receiving a section including ETT table ID extension field having data identification recorded therein only is applied to the received data event ETT section having met the former condition. Thus, the DTV receiver performs the section-filtering through the two conditions. Hence, the DTV receiver receives the data event ETT section that meets the two conditions only (S510).

The data identification recorded in ETT table ID extension field of the data event ETT section, which has met the conditions and is received by the DTV receiver, is read out. It is then decided whether the read-out data identification is equal to data identification stored in a DB. In particular, it is decided whether the data identification recorded in the ETT table ID extension field of the received data event ETT section is equal to, i.e., duplicative with the data identification, which was generated from decoding VCT, stored in the DB (S520).

As a result of the decision (S520), if the two data identification's are not equal to each other, it is decided that the received data event ETT section is not the specific section. So, the received ETT section is discarded and it goes back to the first step (S530). As a result of the decision (S520), if the two data identification's are equal to each other, it is decided that the received data event ETT section is the specific section. And, it goes to a next step.

So, the section-filtering process in the demultiplexer 30 controlled by the PSI/PSIP decoder 80 is completed. And, a process for parsing and processing the data event ETT section received through the section-filtering is identical to that of FIGS. 8 to 12, of which explanation is skipped. In receiving the specific ETT (channel, even or data event), it is decided whether the source identification, event identification or data identification for the specific ETT section is equal to the source identification, event identification or data identification stored in the DB. Yet, the present invention does not put limitation on this.

For instance, after the source identification, event identification or data identification for the specific ETT section has been set, it can be compared to source identification, event identification or data identification set by a user in the section-filtering process instead of being compared to the source identification, event identification or data identification stored in the DB.

In performing the section-filtering on the received ETT section through the header, the unique value (source identification, event identification and data identification) included in the ETT table ID extension field constructing the header of the received ETT section is used. In doing so, it is preferable that there exists information available for deciding whether the unique value exists in the ETT table ID extension field to use the ETT table ID extension field like the flowcharts shown in FIGS. 8 to 13.

Namely, the decision can be previously made by providing the information indicating whether the unique value is recorded in the ETT table ID extension field. In doing so, it is preferable that reserved fields configuring the header of each of the received ETT sections are used in providing the corresponding information. In particular, two reserved fields exist in the table header in FIGS. 2 to 5, which is explained as follows.

In this case, the “reserved” field is a 2-bit reserved field for later use. Hence, in the present invention, one bit of the 2bit reserved field is allocated to provide information field defining the information.

The “information” field is a 1-bit field corresponding to uimsbf (unsigned integer, most significant bit first) and can have a variable value. In this case, the information field according to the present invention uses one of two reserved fields existing within the header. In the present invention, one bit of the two bits is assigned to the “information” field and the rest one bit is assigned as a reserved bit as it is for example. And, another reserved field can be used in the same manner.

As the information field is constructed with one bit, two cases can be defined. Namely, the information field can represent whether it is set or not. If it is set, a value of the field is ‘0’. If the value of the field is ‘0’, the flows shown in FIGS. 8 to 13 are usable since the unique value is defined in the ETT table ID extension field. If it is not set, a value of the field is ‘1’. If the value of the field is ‘1’, the unique value is not defined in the ETT table ID extension field.

The value of the information field is associated with a type of a transmitter. And, there exist three types of the transmitter. A first type corresponds to a case that a value of ETT table ID extension field is ‘0x0000’, a second type corresponds to a case that a value of ETT table ID extension field is a uniqueness value, and a third type corresponds to a case that a value of ETT table ID extension field is source identification or event identification. ETT of the third type has a table type of FIG. 3, FIG. 4 or FIG. 5. And, each of the first and second types will have a table type of FIG. 1.

Hence, ‘the information field is set’ means a case that the ETT table ID extension field is transmitted by the third type transmitter. And, ‘the information field is not set’ means a case that the ETT table ID extension field is transmitted by the first or second type transmitter. So, by deciding a presence or non-presence of the ‘setting’ of the information field value, the type of the transmitter can be known. Hence, the DTV receiver can appropriately cope with the received ETT sections in a manner of deciding whether to perform the section-filtering using the header of each of the received sections only according to the method explained in FIGS. 8 to 13.

Namely, in the present invention, it can be informed that the ETT section is transmitted by what type of the transmitter among the three types using the information field. If the information field value is set, source identification, event identification or data identification will exist in the ETT table ID extension field. If the information field value is not set, a uniqueness value or ‘0x0000’ will exist in the ETT table ID extension field.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A digital television (DTV) signal for use in a digital television (DTV) receiver, the digital television (DTV) signal comprising:
an extended text table (ETT) for data services including a header and a message body, the header including a table identification (ID) extension field which serves to establish uniqueness of the ETT, the message body including an extended text message (ETM), wherein the table ID extension field includes a data identification of a data event associated with the ETT.

2. The digital television (DTV) signal of claim 1, wherein the data identification specifies a unique identification number of the data event associated with the ETT.

3. The digital television (DTV) signal of claim 1, wherein the ETM included in the message body provides detailed descriptions of the data event associated with the ETT.

4. The digital television (DTV) signal of claim 1, wherein the table ID extension field further includes ETM location information which specifies an existence and location of the extended text message (ETM).

5. The digital television (DTV) signal of claim 1, further comprising:
a data event table (DET) corresponding to the ETT, wherein the DET includes title and time information of the data event associated with the ETT.

6. The digital television (DTV) signal of claim 1, wherein the message body further includes an information field specifying a unique identifier of the ETM.

7. The digital television (DTV) signal of claim 6, wherein a part of the unique identifier of the ETM is assigned to the data identification.

8. The digital television (DTV) signal of claim 7, wherein another part of the unique identifier of the ETM is assigned to a source identification of a virtual channel carrying the data event associated with the ETT.

9. The digital television (DTV) signal of claim 8, wherein the source identification specifies a programming source of the virtual channel carrying the data. event associated with the event ETT.

10. A digital television (DTV) signal for use in a digital television (DTV) receiver, the digital television (DTV) signal comprising:
a first extended text table (ETT) for data services including a first header and a first message body, the first header including a first table identification (ID) extension field which serves to establish uniqueness of the first ETT, the first message body including a first extended text message (ETM), wherein the first table ID extension field includes a data identification of a data event associated with the first ETT; and
a second extended text table (ETT) for audio/video services including a second header and a second message body, the second header including a second table identification (ID) extension field which serves to establish uniqueness of the second ETT, the second message body including a second extended text message (ETM), wherein the second table ID extension field including an event identification of an audio/video event associated with the second ETT.

11. The digital television (DTV) signal of claim 10, wherein the data identification specifies a unique identification number of the data event associated with the first ETT.

12. The digital television (DTV) signal of claim 10, wherein the first ETM provides detailed descriptions of the data event associated with the first ETT.

13. The digital television (DTV) signal of claim 10, wherein the second ETM provides detailed descriptions of the audio/video event associated with the second ETT.

14. The digital television (DTV) signal of claim 10, further comprising:
a data event table (DET) corresponding to the first ETT, wherein the DET includes title and time information of the data event associated with the first ETT.

15. The digital television (DTV) signal of claim 10, further comprising:
an event information table (EIT) corresponding to the second ETT, wherein the EIT includes title and time information of the audio/video event associated with the second ETT.

16. The digital television (DTV) signal of claim 10, further comprising:
a third extended text table (ETT) including a third header and a third message body, the third header including a third table identification (ID) extension field which serves to establish uniqueness of the third ETT, the third message body including a third extended text message (ETM), wherein the third table ID extension field including a source identification of a virtual channel associated with the third ETT.

17. The digital television (DTV) signal of claim 16, wherein the third ETM provides detailed descriptions of the virtual channel associated with the third ETT.

18. The digital television (DTV) signal of claim 16, wherein the source identification specifies a programming source of the virtual channel associated with the third ETT.

19. A digital television (DTV) signal for use in a digital television (DTV) receiver, the digital television (DTV) signal comprising:
a first extended text table (ETT) for data services including a first header and a first message body, the first header including a first table identification (ID) extension field which serves to establish uniqueness of the first ETT, the first message body including a first extended text message (ETM), wherein the first table ID extension field includes a data identification of a data event associated with the first ETT; and
a second extended text table (ETT) including a second header and a second message body, the second header including a second table identification (ID) extension field which serves to establish uniqueness of the second ETT, the second message body including a second extended text message (ETM), wherein the second table ID extension field including a source identification of a virtual channel associated with the second ETT.

20. The digital television (DTV) signal of claim 19, wherein the data identification specifies a unique identification number of the data event associated with the first ETT.

21. The digital television (DTV) signal of claim 19, wherein the source identification specifies a programming source of the virtual channel associated with the second ETT.

22. The digital television (DTV) signal of claim 19, wherein the first ETM provides detailed descriptions of the data event associated with the first ETT.

23. The digital television (DTV) signal of claim 19, wherein the second ETM provides detailed descriptions of the virtual channel associated with the second ETT.

24. The digital television (DTV) signal of claim 19, further comprising:
a data event table (DET) corresponding to the first ETT, wherein the DET includes title and time information of the data event associated with the first ETT.

25. A method of processing a digital television (DTV) signal in a digital television (DTV) receiver, the method comprising:
receiving a digital television signal;
demodulating the digital television signal, the demodulated signal including a plurality of extended text tables (ETTs), wherein each ETT comprises a header containing a table identification (ID) extension field which serves to establish uniqueness of each ETT, and a message body containing an extended text message (ETM); and
detecting at least one pertinent ETT for data services by section-filtering the plurality of ETTs based on conditions that the at least one pertinent ETT has a common PID value and that a table ID extension field included in the at least one pertinent ETT includes a specific or non-duplicative data identification.

26. The method of claim 25, further comprising:
parsing the detected at least one pertinent ETT; and
storing an extended text message (ETM) included in the parsed ETT.

27. The method of claim 25, wherein the data identification specifies a unique identification number of a data event associated with the at least one pertinent ETT.

28. The method of claim 25, wherein the ETM included in the message body provides detailed descriptions of a data event associated with the at least one pertinent ETT.

29. A digital television (DTV) receiver, comprising:
a tuner tuned to receive a digital television (DTV) signal;
a demodulator arranged to demodulate the digital television signal, the demodulated signal including a plurality of extended text tables (ETTS), wherein each ETT comprises a header containing a table identification (ID) extension field which serves to establish uniqueness of each ETT, and a message body containing an extended text message (ETM); and
a section-filtering unit arranged to detect at least one pertinent ETT for data services by section-filtering the plurality of ETTs based on conditions that the at least one pertinent ETT has a common PID value and that a table ID extension field included in the at least one pertinent ETT includes a specific or non-duplicative data identification.

30. The digital television (DTV) receiver of claim 29, further comprising:
a decoder arranged to parse the at least one pertinent ETT detected from the section-filtering unit; and
a data storage arranged to store an extended text message (ETM) included in the parsed ETT.

31. The digital television (DTV) receiver of claim 29, wherein the data identification specifies a unique identification number of a data event associated with the at least one pertinent ETT.

32. The digital television (DTV) receiver of claim 29, wherein the ETM included in the message body provides detailed descriptions of a data event associated with the at least one pertinent ETT.

33. The digital television (DTV) receiver of claim 29, the section-filtering unit is a demultiplexer.
